(19) United States
(12) Patent Application Publication
(10) Pub. No.: US 2023/0044385 A1
(43) Pub. Date: Feb. 9, 2023

(54) SEPARATOR STRUCTURE FOR SECONDARY BATTERY, METHOD OF PREPARING THE SAME, ANODE-SEPARATOR ASSEMBLY FOR SECONDARY BATTERY INCLUDING THE SAME, AND SECONDARY BATTERY COMPRISING THE SAME

(71) Applicant: Samsung Electronics Co., Ltd., Suwon-si (KR)

(72) Inventors: Kyounghwan Kim, Seoul (KR); Jirae Kim, Seoul (KR); Joungwon Park, Seongnam-si (KR); Hwiyeol Park, Hwaseong-si (KR); Jeongkuk Shon, Hwaseong-si (KR); Huisu Jeong, Seongnam-si (KR)

(21) Appl. No.: 17/816,741

(22) Filed: Aug. 2, 2022

(30) Foreign Application Priority Data
Aug. 3, 2021 (KR) 10-2021-0102181

(51) Int. Cl. H01M 50/457; H01M 50/446; H01M 50/434; H01M 50/417

(52) U.S. Cl. CPC H01M 50/457; H01M 50/417; H01M 50/434; H01M 50/446; H01M 2004/027

(57) ABSTRACT

A separator structure for a secondary battery includes: a porous substrate; an intermediate layer on the porous substrate and including lithium fluoride (LiF) and a defluorinated polymer; and a lithium metal layer on the intermediate layer. An anode-separator assembly for a secondary battery includes an anode comprising an anode current collector and an anode active material layer on a surface of the anode current collector, and the separator structure. A secondary battery includes the anode-separator assembly, and a cathode on the porous substrate of the anode-separator assembly.

### CROSS-REFERENCE TO RELATED APPLICATION

This application claims priority to Korean Patent Application No. 10-2021-0102181, filed on Aug. 3, 2021, in the Korean Intellectual Property Office, and all the benefits accruing therefrom under 35 U.S.C. § 119, the content of which is incorporated herein by reference in its entirety.

### BACKGROUND

### 1. Field

The present disclosure relates to separator structures for secondary batteries, methods of preparing the same, anode-separator assemblies for secondary batteries including the same, and secondary batteries including the same.

### 2. Description of the Related Art

With recent increased interests in environmental problems, extensive research has been carried out on electric vehicles (EVs) and hybrid electric vehicles (HEVs) that are able to replace vehicles that use fossil fuels, such as gasoline and diesel vehicles, which are one of the major causes of air pollution. Intensive research has been carried out on the use of lithium secondary batteries having high energy density, high discharge voltage, and output stability as a power source of such EVs and HEVs, and some of them have been commercialized.

Lithium secondary batteries are charged and discharged while repeating a process of intercalation of lithium ions of a cathode active material of a cathode into an anode active material of an anode and deintercalation of the lithium ions. Theoretically, intercalation and deintercalation of lithium ions into and out of the anode active material are completely reversible. However, in fact, more lithium is consumed than a theoretical capacity of the anode active material and only a part of it is recovered during discharging. Therefore, although a smaller amount of lithium ions is intercalated during charging after the 2^{nd} cycle, most lithium ions are deintercalated during discharging. Such a capacity difference observed in the 1^{st} charging and discharging cycle is referred to as irreversible capacity loss. In commercialized lithium secondary batteries, lithium ions are supplied from a cathode, and an anode is prepared in a Li-free state, and thus it is important to minimize the irreversible capacity loss during initial charging and discharging.

### SUMMARY

Provided are separator structures for secondary batteries having improved stability and preparing methods thereof.

Provided are anode-separator assemblies for secondary batteries in which a stable solid electrolyte interface (SEI) layer is formed on the surface of an anode by using the separator structures.

Provided are secondary batteries having increased capacity and improved high-rate characteristics by including the above-described anode-separator assemblies for secondary batteries.

Additional aspects will be set forth in part in the description which follows and, in part, will be apparent from the description, or may be learned by practice of the presented embodiments of the disclosure.

According to an aspect of an embodiment, a separator structure for secondary batteries includes a porous substrate, an intermediate layer on the porous substrate and including lithium fluoride (LiF) and a defluorinated polymer, and a lithium metal layer on the intermediate layer.

According to an aspect of another embodiment, an anode-separator assembly for secondary batteries includes an anode including an anode current collector and a first anode active material layer on one surface of the anode current collector, and the above-described separator structure on the anode.

According to an aspect of another embodiment, a secondary battery includes the above-described anode-separator assembly, and a cathode on the porous substrate of the anode-separator assembly.

According to an aspect of another embodiment, a secondary battery includes: an anode including an anode current collector and an anode active material layer on the anode current collector; and a separator structure including a porous substrate, and an intermediate layer on the porous substrate and including a defluorinated polymer and lithium fluoride (LiF).

The anode can be an anode lithiated by pre-lithiation.

According to an aspect of another embodiment, a method of preparing a separator structure for secondary batteries includes forming a fluorine layer comprising a fluorine-containing polymer on a porous substrate, and preparing the above-described separator structure for secondary batteries by forming a lithium metal layer on the fluorine layer.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A shows an embodiment of a structure of a separator structure;

FIG. 1B shows an embodiment of a structure of an anode in which an anode active material layer is located on an anode current collector;

FIG. 1C schematically shows an embodiment of a structure of a pre-lithiated anode-separator assembly;

FIG. 2A schematically shows an embodiment of a structure of an anode-separator assembly;

FIG. 2B schematically shows another embodiment of a structure of an anode-separator assembly;

FIG. 3 is a graph illustrating discharge capacity properties (milliampere-hours per gram, mAh/g) of lithium secondary batteries prepared according to Preparation Example 1 and Comparative Preparation Example 1 at the 1^{st} cycle.

FIG. 4 shows high-rate capacity retention ratios (%) of lithium secondary batteries prepared according to Preparation Example 1 and Comparative Preparation Example 1;

FIG. 5 is a perspective view of an embodiment of a secondary battery.

FIG. 6 is a perspective view of an embodiment of a structure of a cathode; and

FIG. 7 is a cross-sectional view taken along line A-A of the cathode shown in FIG. 6.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain various aspects. As used herein, the term “and/or” includes any and all combinations of one or more of the associated listed items. “Or” means “and/or.” Expressions such as “at least one of,” when preceding a list of elements, modify the entire list of elements and do not modify the individual elements of the list.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer or section from another element, component, region, layer or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature’s relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ± 30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Separator structures for secondary batteries, preparing methods thereof, anode-separator assemblies for secondary batteries including the same, and secondary batteries including the same according to embodiments of the present disclosure will be described in more detail with reference to the accompanying drawings.

To solve the problem of low initial charging/discharging efficiency of lithium secondary batteries, a method of coating a separator with a lithium metal layer and forming a barrier layer including a binder soluble in an electrolytic solution between a lithium metal layer and a separator has been suggested.

According to this suggested method of forming the barrier layer, lithium metal of a lithium metal layer additionally supplies lithium ions to a lithium secondary battery to form a solid electrolyte interface (SEI) layer at the time of initial charging and discharging to compensate for the loss of lithium ions, and thus initial efficiency may be increased. However, because the barrier layer is soluble in the electrolytic solution, a viscosity of the electrolytic solution may increase thereby increasing resistance. In addition, because pores of the separator may be filled with a barrier layer-forming material, migration of the electrolytic solution is suppressed and a high-rate characteristics of the lithium secondary battery may be deteriorated.

A separator structure for secondary batteries according to an embodiment of this disclosure may solve the above-described problems and provide a secondary battery having improved high-rate characteristics.

A separator structure according to an embodiment includes a porous substrate, an intermediate layer located on the porous substrate and including lithium fluoride (LiF) and a defluorinated polymer, and a lithium metal layer located on the intermediate layer.

The lithium metal layer is formed to have a thickness sufficient to compensate for irreversible loss of lithium metal during a first charging/discharging cycle of the secondary battery. According to another embodiment, the lithium metal layer may have a thickness enough to provide a sum of a lithium content to compensate for irreversible capacity loss of an anode during charging and discharging of the secondary battery and a lithium content required for defluorination of the fluorine containing polymer that is a starting material for forming the intermediate layer.

The intermediate layer includes lithium fluoride and a defluorinated polymer, and a composition of the intermediate layer may be identified by X-ray photoelectron spectroscopy (XPS). Through this analysis, Li—F and C—F bonds may be confirmed.

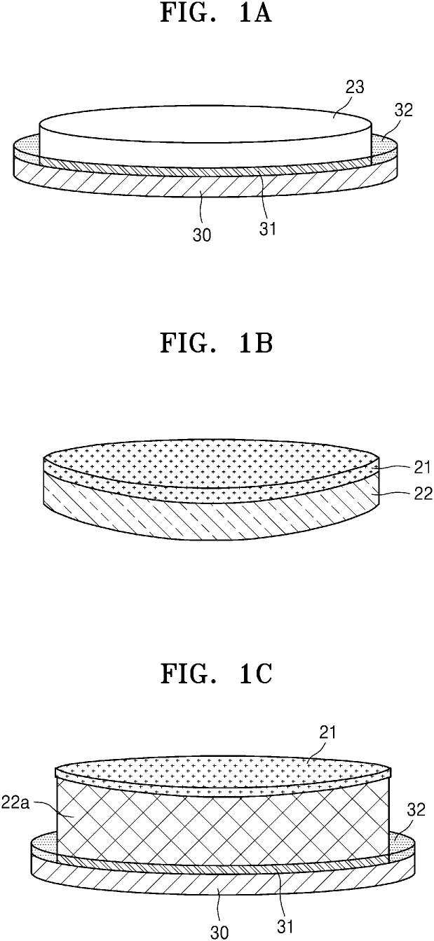

FIG. 1A shows a structure of an embodiment of a separator structure.

An intermediate layer 31 including a defluorinated polymer and lithium fluoride is located on a portion (a central region) of one surface of a porous substrate 30 and an adhesive layer 32 including a fluorine-containing polymer is located on another portion (a peripheral region) of the surface of the porous substrate 30. The adhesive layer 32 is located on an exposed surface of the porous substrate 30 where the intermediate layer 31 is not located as shown in FIG. 1A. In addition, a lithium metal layer 23 is located on the intermediate layer 31. The intermediate layer 31 and the lithium metal layer 23 have structures in contact with each other as shown in FIG. 1A.

The intermediate layer 31 has ionic conductivity and is not soluble in the electrolytic solution. Therefore, a problem of resistance increasing due to high viscosity of an electrolytic solution, which increases as a material used to form a barrier layer is dissolved in an electrolytic solution, is avoided. In addition, a stable SEI layer is formed between the intermediate layer and the separator (porous substrate) after charging and discharging. The SEI layer formed at the time of initial charging prevents reactions between lithium ions and the anode or other materials and serves as an ion tunnel transmitting only lithium ions during charging and discharging to inhibit decomposition of the electrolyte, thereby contributing to the improvement of cycle characteristics of the lithium secondary battery. Therefore, high-rate characteristics of the secondary battery may be improved.

The intermediate layer 31 is disposed on about 88% to about 99.5%, about 90% to about 99.5% or about 92 to about 99% of an exposed surface of the porous substrate 30. In addition, the adhesive layer 32 includes a fluorine-containing polymer and is formed on the periphery of the intermediate layer 31 as shown in FIG. 1A. By forming the adhesive layer 32 as described above, adhesion between the separator (porous substrate) and the intermediate layer, and adhesion between the lithium metal layer and the intermediate layer constituting the separator structure may be improved and heat resistance may be improved, and thus secondary batteries having enhanced safety may be manufactured.

The lithium metal layer may reduce initially occurring irreversible capacity loss caused by formation of the SEI layer or the like and may compensate for irreversible capacity in the case of using an anode active material with high irreversible capacity, and thus anodes having increased energy density may be provided.

The lithium metal layer according to an embodiment has a thickness capable of providing both a lithium content to compensate for an irreversible capacity loss of an anode and a lithium content required for defluorination of the fluorine containing polymer of the intermediate layer during charging and discharging of the secondary battery. The lithium metal layer has a thickness capable of providing a lithium content satisfying Equation 1 below:

$$\text{c} = \text{a} + \text{b} \text{.}$$

In Equation 1, c is a lithium content of the lithium metal layer, a is a lithium content required to form lithium fluoride (LiF) via a reaction with the fluorine-containing polymer, and b is a lithium content irreversibly lost from the anode during charging and discharging of the secondary battery.

A thickness c1 of the lithium metal layer is adjusted to satisfy the relationship of Equation 2 below.

$$\text{C1} = \text{a1} + \text{b1} \text{.}$$

In Equation 2, a1 indicates a thickness of lithium metal required to form lithium fluoride via a reaction with the fluorine-containing polymer, and b1 indicates a deposition thickness of the lithium metal layer related to pre-lithiation of an anode.

The unit of thickness of a1, b1 and c1 is micron (µm), and a1 and b1 may be obtained by Equations 2-1 and 2-2 below, respectively:

$$\begin{matrix}\text{wherein a1=} \left(\text{mass of fluorine-containing polymer}\right) \times \\ \left(\text{capacity per unit weight of}\right. \\ \left.\text{fluorine-containing polymer}\right) \times \\ \left(\text{1/theoretical capacity of Li}\right) \times \\ \left(1 \text{/deposition area of lithium}\right. \\ \left.\text{metal layer}\right) \times \left(1 \text{/density of Li}\right) \times \left(1 / 10 , 000\right) .\end{matrix}$$

In Equation 2-1, the unit of mass of the fluorine-containing polymer is g, and the unit of the capacity per unit weight of the fluorine-containing polymer is mAh/g. When the fluorine-containing polymer is polytetrafluoroethylene (PTFE), the capacity per unit weight of the fluorine-containing polymer is 1070 mAh/g, the theoretical capacity of Li is 3860 mAh/g, the unit of the deposition area is cm², and the Li density is 0.53 g/cm³. In addition, in Equation 2-1, 1/10,000 is used to convert the unit of the thickness a1 from cm to µm.

$$\begin{matrix}\text{b1=} \left(\text{irreversible capacity of anode}\right) \times \\ \left(1 \text{/theoretical capacity of Li}\right) \times ( 1 \text{/deposition} \\ \left.\text{area of lithium metal layer}\right) \times \left(1 \text{/density of Li}\right) \times \\ \left(1 / 10000\right) .\end{matrix}$$

In Equation 2-2, the unit of the irreversible capacity of the anode is mAh, the theoretical capacity of Li is 3860 mAh/g, the unit of the deposition area is cm², and the Li density is 0.53 g/cm³. In addition, in Equation 2-2, 1/10,000 is used to convert the unit of the thickness b1 from cm to µm.

The defluorinated polymer and lithium fluoride may be present in pores of the porous substrate. In the case where the defluorinated polymer and lithium fluoride are present in the pores of the porous substrate, a separator structure having excellent mechanical properties may be prepared without forming a first coating layer on the separator (porous substrate) and including ceramic particles and a binder.

Lithium fluoride (LiF) and the defluorinated polymer of the intermediate layer are products of a reaction between the fluorine-containing polymer and lithium.

When Li metal is deposited on a separator (porous substrate) on which a fluorine-containing polymer such as PTFE is disposed, LiF is conformally coated along the surface.

On the other hand, because a polyvinylidenefluoride (PVDF) film and a lithium metal film are in point contact with each other in a reaction therebetween, a bonding interface is formed by applying pressure thereto to form LiF, and thus LiF may be formed nonuniformly.

The defluorinated polymer is a product obtained by partially removing fluorine from the fluorine-containing polymer. When the fluorine-containing polymer is polytetrafluoroethylene, the defluorinated polymer may be, for example, a polymer represented by Formula 1 below:

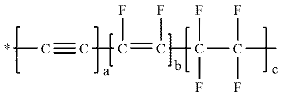

In Formula 1, a, b and c are mole fractions, respectively, from 0.01 to 0.99, and the sum thereof is 1.

In Formula 1, a, b, and c are each independently 0.01 to 0.99, 0.2 to 0.8, 0.3 to 0.7, or 0.4 to 0.6, and a + b + c = 1.

In an embodiment, a and b are each independently 0.01 to 0.99, 0.2 to 0.8, 0.3 to 0.7, or 0.4 to 0.6, c is 0.01 to 0.99, 0.2 to 0.8, 0.3 to 0.7, or 0.4 to 0.6, and a + b + c = 1.

A degree of polymerization of the fluorine-containing polymer or the defluorinated polymer may be adjusted such that a number average molecular weight of each is from about 10,000 to about 200,000 g/mol, or from about 50,000 to about 150,000 g/mol, or about 120,000 g/mol.

The polymer of Formula 1 that is a defluorinated polymer is more rigid than polytetrafluoroethylene, and thus a separator structure having excellent mechanical properties may be manufactured.

The intermediate layer may be obtained by forming a fluorinated polymer-containing layer (also referred to as “a fluorine layer comprising a fluorine-containing polymer”) on the porous substrate of the separator (porous substrate) and forming a lithium metal layer thereon. The fluorinated polymer-containing layer may be formed by either a dry or wet process. The lithium metal layer may be formed on the fluorinated polymer-containing layer by depositing lithium thereon. As a result, the intermediate layer and the lithium metal layer may constitute an integrated structure.

The reaction between the fluorinated polymer-containing layer and the lithium metal layer proceeds as shown in Reaction Scheme 1 below to form the intermediate layer including the defluorinated polymer and lithium fluoride:

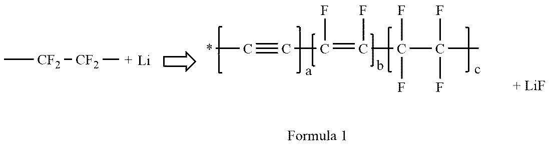

In Reaction Scheme 1, a, b and c of Formula 1 represent mole fractions, respectively, which are from 0.01 to 0.99, and the sum thereof is 1.

The defluorinated polymer of the intermediate layer can be a polymer including an unsaturated monomer repeating unit constituting a rigid chain and a fluorine-containing monomer repeating unit constituting a flexible chain. The unsaturated monomer repeating unit can be an unsaturated defluorinated monomer repeating unit derived from the reaction between lithium and the fluorine-containing polymer. The fluorine-containing monomer repeating unit can be a saturated repeating unit that is originally present in the fluorine-containing polymer before the fluorine-containing polymer is reacted with lithium. In Formula 1, the unsaturated defluorinated monomer repeating unit is a repeating unit having mole fractions of a and b, and the fluorine-containing monomer repeating unit is a repeating unit having a mole fraction of c. In Formula 1, a, b, and c are from 0.1 to 0.9, from 0.2 to 0.8, from 0.3 to 0.7, or 0.4 to 0.6, respectively.

The defluorinated polymer has excellent mechanical properties by including the rigid chain and excellent processibility by including the flexible chain.

The fluorine-containing polymer may include, for example, polytetrafluoroethylene, polyvinylidenefluoride, polyhexafluoropropylene, polychlorotrifluoroethylene, polyvinylfluoride, polyperfluoroalkoxyalkane, fluorinated ethylenepropylene polymer, perfluoroelastomer, an ethylene chlorotrifluroethylene copolymer, or a combination thereof.

A process of forming the lithium metal layer may be performed, for example, by depositing lithium metal. When the lithium metal layer is formed according to such a process, a separate pressing process is not necessary.

FIG. 1B shows a structure of an anode in which an anode active material layer 22 is located on an anode current collector 21. The anode active material layer is a first anode active material layer. In addition, FIG. 1C shows a state of an anode-separator assembly prepared by stacking the anode active material layer 22 of the anode of FIG. 1B on the lithium metal layer 23 of the separator structure of FIG. 1A and performing charging and discharging. The anode active material layer 22 is converted into a pre-lithiated anode active material layer 22a by charging and discharging as shown in FIG. 1C.

According to an embodiment, the anode active material layer 22 includes a silicon-based anode active material (also referred to as “silicon anode active material”), and the pre-lithiated anode active material layer 22a may include a lithiated silicon-based anode active material.

A thickness of the intermediate layer is, for example, from about 0.0005 µm to about 2.5 µm, from about 0.1 µm to about 1.5 µm, or from about 0.5 µm to about 1.2 µm, and a thickness of the lithium metal layer is, for example, from about 0.0005 µm to about 20 µm, from about 0.1 µm to about 10 µm, or from about 1 µm to about 5 µm. The thickness of the lithium metal layer may be about 0.01 % to about 20% of the thickness of the anode. In this regard, the anode includes the anode current collector and the anode active material layer. In addition, in the intermediate layer, a size of lithium fluoride is from about 1 nanometer (nm) to about 1000 nm, from about 5 nm to about 500 nm, or from about 10 nm to about 50 nm.

When the thickness of the intermediate layer and the size of lithium fluoride are within the above ranges, a stable SEI layer may be formed, so that secondary batteries having improved high-rate characteristics may be manufactured. In addition, when the thickness of the lithium metal layer is within the above range, anodes having increased capacity may be prepared.

A ratio of a thickness of the lithium metal layer to a thickness of the intermediate layer is from about 40,000:1 to about 1.15:1, from about 20,000:1 to about 1.5:1, from about 10,000:1 to about 1.8:1, from about 100:1 to about 2:1, or from about 50:1 to about 3:1.

As used herein, the term “size” refers to an average particle diameter when an object to be measured has a spherical shape and refers to a long axis when an object to be measured has a non-spherical shape. The average particle diameter may be evaluated by a particle size analyzer or a scanning electron microscope (SEM). The average particle diameter may be a median value D50 based on volume. The average particle diameter is measured by, for example, a laser diffraction analyzer or a dynamic light-scattering analyzer. The average particle diameter may be measured by using a laser scattering particle size distribution analyzer (e.g., LA-920 from Horiba Instruments, Inc.) and is a median particle diameter D50 corresponding to 50% of particles in a cumulative distribution curve in which particles accumulated in the order of volume from the smallest particle.

An area of the intermediate layer may be equal to or smaller than a total area of the porous substrate, and an area of the lithium metal layer may be smaller than a total area of the intermediate layer and equal to or greater than a total area of the anode of the secondary battery.

An adhesive layer including a fluorine-containing polymer may further be included between the porous substrate and the intermediate layer.

The porous substrate is a porous film including polyolefin. For example, the porous substrate is a film formed of a resin of a polyolefin such as polyethylene, polypropylene, polybutene, and polyvinyl chloride, and a mixture or copolymer thereof.

The polyolefin used as a material of the porous substrate may be, for example, a homopolymer, copolymer or mixture of polyethylene and polypropylene. Polyethylene may be low-density, medium-density, or high-density polyethylene, and high-density polyethylene may be used in terms of mechanical strength.

The porous substrate includes, for example, a polyolefin such as polyethylene and polypropylene and may be a multilayer film of two or more layers. The porous substrate may be a mixed multilayer film such as a polyethylene/polypropylene double-layered separator, a polyethylene/polypropylene/polyethylene triple-layered separator, and a polypropylene/polyethylene/polypropylene triple-layered separator.

The porous substrate may include a diene-based polymer prepared by polymerizing a monomer composition including a diene-based monomer. The diene-based monomer may be a conjugated diene-based monomer or a non-conjugated diene-based monomer. For example, the diene-based monomer may include at least one selected from the group consisting of 1,3-butadiene, isoprene, 2-chloro-1,3-butadiene, 2,3-dimethyl-1,3-butadiene, 2-ethyl-1,3-butadiene, 1,3-pentadiene, chloroprene, vinylpyridine, vinylnorbornene, dicyclopentadiene, and 1,4-hexadiene, but is not limited thereto, and any diene-based monomer commonly used in the art may also be used.

According to an embodiment, the porous substrate includes polyethylene, polypropylene, or a combination thereof. A thickness of the porous substrate is from about 1 µm to about 100 µm, a porosity of the porous substrate is from about 5% to about 95%, and a pore size of the porous substrate is from about 0.01 µm to about 20 µm. The thickness of the porous substrate is, for example, from about 1 µm to about 30 µm, from about 5 µm to about 20 µm, or from about 5 µm to about 15 µm. The porosity of the porous substrate is, for example, from about 10% to about 85%. In the separator structure, the pore size of the porous substrate is from about 0.01 µm to about 20 µm or from about 0.01 µm to about 10 µm. When the thickness, the pore size, and the porosity of the porous substrate are within the above ranges, excellent mechanical properties may be obtained without increasing internal resistance of the secondary battery.

A first coating layer including ceramic particles and a binder may be disposed on the porous substrate. The ceramic particles can include particles of inorganic material, such as, alumina (Al₂O₃), boehmite, BaSO₄, MgO, Mg(OH)₂, clay, silica (SiO₂), TiO₂, ZrO, CaO, attapulgite, 10SiO₂-2Al₂O₃—Fe₂O₃—2MgO, or a combination thereof.

The binder may be, for example, polyvinylalcohol, a sulfonate-based compound, an acrylamide-based compound, a (meth)acrylic-based compound, an acrylonitrile-based compound, or a derivative, copolymer, mixture, or combination thereof, but is not limited thereto. The binder includes at least one selected from polyvinylalcohol, poly(acrylic acid-co-acrylamide-co-2-carylamido-2-methylpropanesulfonic acid)sodium salt, poly(acrylic acid), poly(acrylamide), poly(acrylamido sulfonic acid), and a salt thereof. A thickness of the first coating layer is from about 0.1 µm to about 5.0 µm, from about 0.3 µm to about 4.0 µm, or from about 0.5 µm to about 3.5 µm.

An average particle size of the ceramic particles is from about 1 µm to about 20 µm, from about 1.1 µm to about 18 µm, from about 3 µm to about 16 µm, or from about 5 µm to about 15 µm. In this regard, the average size means an average length. The average size and average length may be identified by using a scanning electron microscope (SEM). An ultra-high resolution field emission scanning electron microscope (FE-SEM) (S-4700 manufactured by Hitachi High Technologies Co.) is used as an SEM analyzer. Images of randomly selected 50 particles are obtained using the SEM analyzer and an average length is set as an average size. When the ceramic particles have the above-described average size, separators having high ionic conductivity, excellent air permeability, and excellent shut-down effect may be prepared. In addition, a density of the ceramic particles can be, for example, from about 0.2 gram per square centimeter (g/cm²) to about 0.5 g/cm², from about 0.25 g/cm² to about 0.45 g/cm², from about 0.3 g/cm² to about 0.4 g/cm², or from about 0.35 g/cm² to about 0.37 g/cm².

The separator including the first coating layer that includes ceramic particles and a binder may be formed by coating a ceramic coating layer composition including the ceramic particles and a solvent on a porous substrate and drying the coating. The coating may be conducted, for example, by printing, roller coating, blade coating, dip coating, and spray coating.

An adhesive layer including a fluorine-containing polymer may further be included between the porous substrate and the intermediate layer.

According to another embodiment, provided is an anode-separator assembly for secondary batteries including: an anode including an anode current collector and a first anode active material layer located on one surface of the anode current collector; and the above-described separator structure located on the anode.

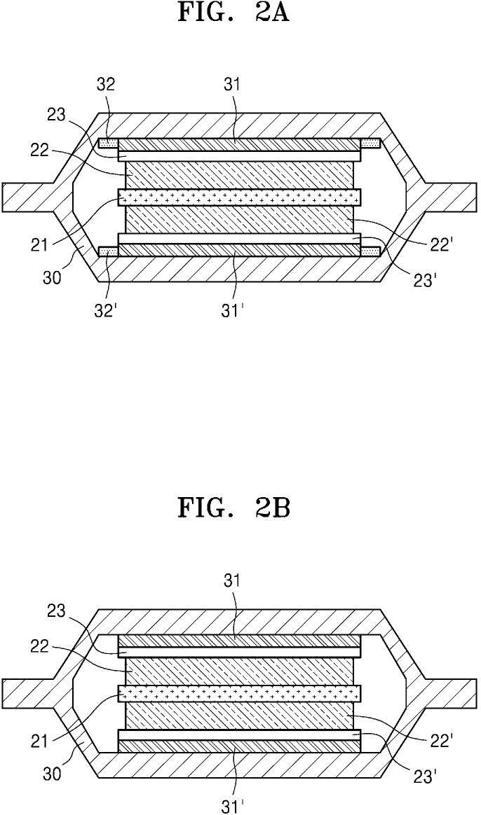

The above-described anode-separator assembly includes a first separator including a first porous substrate, and the anode-separator assembly may further include: a second anode active material layer located on the other surface of the anode current collector of the anode-separator assembly; a second lithium metal layer located on the second anode active material layer; a second intermediate layer located on the second lithium metal layer and including a defluorinated polymer and lithium fluoride (LiF); and a second separator including a second porous substrate located on the second intermediate layer. The anode-separator assembly may have a structure in which the anode is enclosed by the first and second separators by bonding ends (edges) of the first and second separators. Such structures of the anode-separator assembly are shown in FIGS. 2A and 2B.

The anode-separator assembly may further include a second adhesive layer arranged to extend from the ends of the second intermediate layer and including a fluorine-containing polymer.

FIGS. 2A and 2B show stack structures of anode-separator assemblies in which an anode is pocketed by separators according to an embodiment.

Referring to FIG. 2A, the anode-separator assembly has a structure in which a first anode active material layer 22, a first lithium metal layer 23, and a first intermediate layer 31 are sequentially arranged on one surface of an anode current collector 21. A first adhesive layer 32 is located at a peripheral or end portion of the first intermediate layer 31 to surround the first intermediate layer 31. In addition, on the other surface of the anode current collector 21, a second anode active material 22', a second lithium metal layer 23', and a second intermediate layer 31' are sequentially arranged as shown in FIG. 2A, and a second adhesive layer 32' is located at a peripheral or end portion of the second intermediate layer 31'. The edges of the separators 30 (porous substrates) are bonded to each other, and thus the anode-separator assembly has a structure in which the anode is pocketed by the separators, the anode having a structure in which the first anode active material layer 22 and the second anode active material layer 22' are stacked on both surfaces of the anode current collector 21, respectively. By this structure in which the anode is enclosed by the separators (porous substrates) as described above, it is possible to effectively prevent performance deterioration of the lithium metal layer and the anode, which are highly reactive, during a secondary battery manufacturing process. As a result, the battery has good safety.

The first adhesive layer 32 and the second adhesive layer 32' are arranged at the peripheral or end portions of the first intermediate layer 31 and the second intermediate layer 31' respectively extending from the centers and include a fluorine-containing polymer. In this regard, a total area of the second intermediate layer and the second adhesive layer may be controlled to be equal to or smaller than a total area of the porous substrate 30 as the separator.

Although not shown in the drawings, a first coating layer including ceramic particles and a binder may further be formed between the separator 30 (porous substrate) and the first intermediate layer 31 and/or between the separator 30 and the second intermediate layer 31'.

The anode-separator assembly of FIG. 2B has the same structure as that of FIG. 2A, except that the adhesive layer is not present at the peripheral portion of the intermediate layers 31 and 31'.

In the case where a secondary battery is manufactured using the anode-separator assembly according to an embodiment, the intermediate layer and the lithium metal layer are formed on the anode and the anode active material layer and the lithium metal layer are in contact with each other in the formation of a stack, and thus safety of the secondary battery may be obtained. When the intermediate layer is formed on the lithium metal layer located on the anode, the lithium metal layer located on the anode is in the state of a highly reactive lithiated anode. Thus, there is high possibility of performance deterioration in a secondary battery during a secondary battery manufacturing process.

According to another embodiment, provided is a secondary battery including: the anode-separator assembly according to an embodiment; and a cathode located on a porous substrate of the anode-separator assembly.

The secondary battery may be in a state where a charging and discharging process is not performed after the battery is assembled.

The secondary battery may be, for example, a secondary battery for mobile devices and wearable devices. In addition, the anode of the secondary battery has increased capacity by pre-lithiation to have an energy density of about 600 Watt- hours per liter (Wh/L) or more, for example about 600 Wh/L to about 1000 Wh/L.

In the secondary battery, the anode active material layer may include a metal or metalloid anode active material, a carbonaceous anode active material, or any combination thereof. According to an embodiment, the anode active material layer may include an anode active material having a high irreversible capacity.

The anode active material layer may be, for example, a silicon-based anode active material. The silicon-based anode active material may include silicon, a silicon-carbon composite, SiOₓ (where 0 < x < 2), an Si-Q alloy (where Q is an element of alkali metals, alkali earth metals, elements of groups 13, 14, 15, and 16, transition metals, rare earth elements, and any combination thereof, except for Si), or any combination thereof and may be a mixture of at least one of these materials and SiO₂.

The element Q may Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or any combination thereof.

The anode active material layer may be a silicon-carbon composite including silicon particles and a first carbonaceous material, a silicon-carbon composite including a core in which silicon particles and a second carbonaceous material are mixed and a third carbonaceous material surrounding the core, or a combination thereof.

The first to third carbonaceous materials may be each independently crystalline carbon, amorphous carbon, or any combination thereof. The silicon-carbon composite includes a core including silicon particles and crystalline carbon and an amorphous carbon coating layer formed on the surface of the core.

In the case where the above-described silicon-carbon composite is used as the silicon-based active material, the secondary battery may have high capacity and stable cycle characteristics.

In the silicon-carbon composite including the silicon particles and the first carbonaceous material, an amount of silicon particles may be from about 30 wt% to about 70 wt%, for example, from about 40 wt% to about 50 wt%. An amount of the first carbonaceous material may be from about 70 wt% to about 30 wt%, for example, from about 50 wt% to about 60 wt%. When the amounts of the silicon particles and the first carbonaceous material are within the above ranges, the secondary battery may have high capacity and excellent lifespan characteristics.

Alternatively, the silicon-based active material may include a silicon-carbon composite including a core in which silicon particles and the second carbonaceous material are mixed and the third carbonaceous material surrounding the core. By using the silicon-carbon composite, the secondary battery may have very high capacity, increased capacity retention ratio, and enhanced lifespan characteristics at high temperature. In this regard, the third carbonaceous material may have a thickness of about 5 nm to about 100 nm, about 10 nm to about 90 nm, or about 15 nm to about 80 nm. In addition, the third carbonaceous material may be included in an amount of about 1 wt% to about 50 wt% or about 5 wt% to about 40 wt%, and the silicon particles may be included in an amount of about 30 wt% to about 70 wt% or about 40 wt% to about 60 wt%, based on 100 wt% of the silicon-carbon composite. The second carbonaceous material may be included in an amount of about 20 wt% to about 69 wt% or about 30 wt% to about 60 wt%. When the amounts of the silicon particles, the third carbonaceous material, and the second carbonaceous material are within the ranges above, the secondary battery may have high discharge capacity and increased capacity retention ratio.

The silicon particles may have a particle diameter of about 10 nm to about 30 µm, for example, about 10 nm to about 1000 nm, or about 20 nm to about 150 nm. When an average particle diameter of the silicon particles is within the ranges above, volume expansion occurring during charging and discharging may be suppressed and disconnection of electron transfer caused by breakage of particles during charging and discharging may be inhibited.

In the silicon-carbon composite, for example, the second carbonaceous material may be crystalline carbon, and the third carbonaceous material may be amorphous carbon. That is, the silicon-carbon composite may be a silicon-carbon composite including a core including silicon particles and crystalline carbon and an amorphous carbon coating layer formed on the surface of the core.

The crystalline carbon may be artificial graphite, natural graphite, or any combination thereof. The amorphous carbon may include at least one selected from pitch carbon, soft carbon, hard carbon, mesophase pitch carbonization product, sintered coke, carbon fiber, or any combination thereof. A precursor of the amorphous carbon may be coal-based pitch, mesophase pitch, petroleum-based pitch, coal-based oil, petroleum-based heavy oil, or a polymer resin such as phenol resin, furan resin, and polyimide resin.

The silicon-carbon composite can include about 10 wt% to about 60 wt% or about 20 wt% to about 50 wt% of silicon and about 40 wt% to about 90 wt% or about 50 wt% to about 80 wt% of the carbonaceous material based on 100 wt% of the silicon-carbon composite. In addition, in the silicon-carbon composite, an amount of the crystalline carbon is from about 10 wt% to about 70 wt% or about 20 wt% to about 60 wt% and an amount of the amorphous carbon is from 20 wt% to 40 wt% or about 25 wt% to about 35 wt% based on a total weight of the silicon-carbon composite.

The silicon particles may be present in an oxidized form and an atomic ratio of Si:O in the silicon particles that indicates the degree of oxidation is from about 99:1 to about 33:66 by atom. The silicon particles may be SiOₓ particles, and in this case where a range of X in SiOₓ may greater than 0 and less than 2. In this regard, unless otherwise defined, the average particle diameter D50 refers to a diameter of a particle having a cumulative volume of about 50 % by volume in particle size distribution.

The secondary battery according to an embodiment is a lithium secondary battery. The lithium secondary battery may be, for example, a lithium-ion secondary battery.

In the secondary battery according to an embodiment, the anode may be pre-lithiated. A degree of pre-lithiation of the anode is represented by Equation 3 below and may be, for example, from about 25 to about 70% or from about 25 to about 50%: Equation 3 Degree of pre-lithiation=(capacity of pre-lithiated anode)/(capacity of anode)x100.

When the degree of pre-lithiation of the anode is within the above range, reduction of lithium ions caused by initial irreversible capacity loss of the anode may be effectively compensated for.

A charge capacity of the pre-lithiated anode is from about 10% to about 100%, from about 20% to about 90%, or from about 30% to about 90% relative to a charge capacity of a cathode. When the charge capacity of the pre-lithiated anode is within the above range, lithium can be electrodeposited on the anode to an appropriate degree without deteriorating safety of the secondary battery, and thus lithium may be compensated for in the case of deterioration of the lithium battery.

According to another embodiment, provided is a secondary battery including: an anode including an anode current collector and an anode active material layer located on the anode current collector; and a separator structure including a porous substrate and an intermediate layer that is located on the porous substrate and includes a defluorinated polymer ad lithium fluoride (LiF). The anode is lithiated by pre-lithiation.

The above-described secondary battery has a structure in which the lithium metal layer is separately present before a charging and discharging process is conducted but is not present after the charging and discharging process is conducted.

Hereinafter, a method of preparing a separator structure for secondary batteries according to an embodiment will be described.

First, a fluorine-containing polymer-containing layer is formed on the surface of a porous substrate, and a lithium metal layer is formed on the fluorine- containing polymer-containing layer to prepare an intermediate layer on the porous substrate.

The fluorine-containing polymer-containing layer may be formed by a wet or dry method.

By the wet method, the fluorinated polymer-containing layer is formed by preparing a composition by mixing a fluorine-containing polymer and a solvent, coating the composition on the porous substrate, and drying the coated composition. As the composition, a fluorinated polymer-containing waterborne solution may be used. The composition may be, for example, a waterborne solution including about 40 wt% to about 70 wt% or about 60 wt% of polytetrafluoroethylene. An amount of the above-described fluorinated polymer-containing waterborne solution is adjusted to be from about 1 wt% to about 10 wt% or from about 2.5 wt% to about 8 wt% based on a total weight of the separator including the porous substrate and the fluorinated polymer-containing layer. The drying is performed at a temperature of about 80° C. to about 120° C.

By the dry method, the fluorinated polymer-containing layer may be formed by sputtering using a fluorine-containing polymer target. This is a surface coating process in which the fluorine-containing polymer separated in a molecular level by plasma generated by applying a strong energy to the surface of the fluorine-containing polymer is deposited onto the surface of an adherent located on the opposite side. The sputtering may be performed by using, for example, radio frequency (RF) magnetron sputtering.

The forming of the lithium metal layer may be performed by, for example, depositing lithium metal. In the lithium metal deposition, lithium metal is selectively deposited only on a portion of the fluorinated polymer-containing layer to form a structure in which the intermediate layer is formed on a central area of the separator and the adhesive layer is formed at a periphery area thereof as shown in FIG. 1A.

FIG. 5 is a perspective view schematically illustrating a structure of a secondary battery according to an embodiment.

Referring to FIG. 5, a secondary battery 1 includes a cathode 10; an anode 20; a separator structure 30 according to an embodiment between the cathode 10 and the anode 20; and a liquid electrolyte impregnated into the separator structure 30. The anode 20 and the separator structure 30 are combined to form the anode-separator assembly.

The secondary battery 1 may provide increased capacity and improved high-rate characteristics by including the above-described separator structure. The separator structure 30 prevents short-circuits by inhibiting contact between the cathode 10 and the anode 20. In addition, the separator structure 30 impregnated with the liquid electrolyte conducts ions but blocks electrons between the cathode 10 and the anode 20.

The secondary battery 1 is, for example, a lithium secondary battery.

The cathode of the secondary battery may be a three-dimensional high-density cathode.

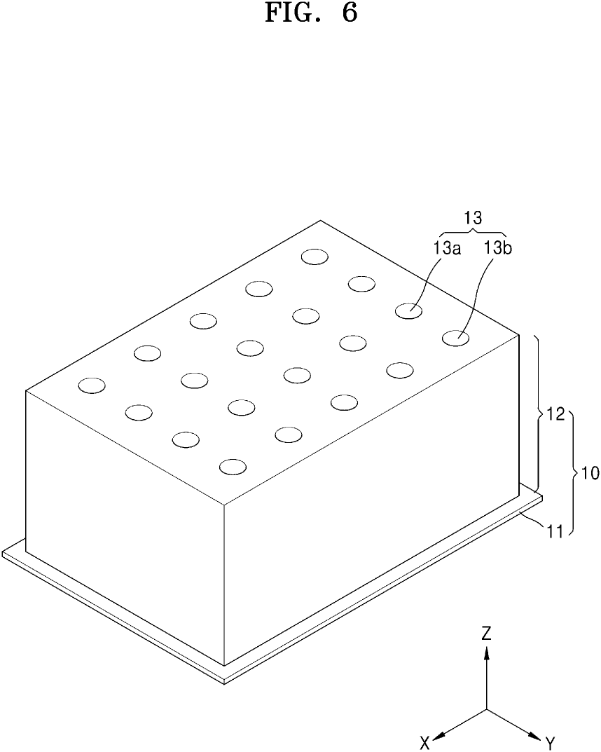

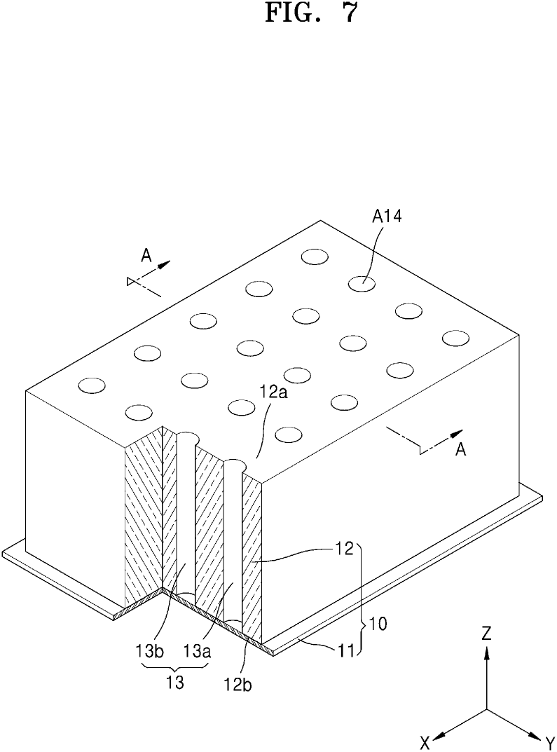

The cathode of the secondary battery may include, for example, a cathode active material layer having, for example, a channel structure. FIG. 6 is a perspective view of such a cathode. FIG. 7 is a cross-sectional view of a cathode active material layer having a channel structure according to an embodiment.

Referring to FIGS. 6 and 7, a cathode active material layer 12 having a channel structure 13 has a three-dimensional structure. A secondary battery including the cathode active material layer 12 having a three-dimensional has significantly increased capacity and energy density of the secondary battery compared to a secondary battery including a cathode active material layer having a two-dimensional structure (i.e., planar structure). The cathode active material layer 12 having the three-dimensional structure may have an increased volume fraction of the cathode active material and a wider reaction area compared to those of a planar-type cathode active material layer. Thus, the energy density and high-rate characteristics of the secondary battery may be efficiently improved thereby.

Referring to FIGS. 6 to 7, the cathode active material layer 12 having a three-dimensional structure may include a channel structure 13 extending from one surface 12a of the cathode active material layer 12 to the other surface 12b of the cathode active material layer 12.

Because of the cathode active material layer 12 includes the channel structure 13, a reaction area of the cathode active material layer 12 may be increased. In addition, because the cathode active material layer 12 includes the channel structure 13, an electrolyte (not shown) is present to the inside of the cathode active material layer 12 after assembling the battery, and thus a conduction path of ions may be significantly shortened in the cathode active material layer 12. Therefore, the secondary battery including the cathode 10 including the cathode active material layer 12 having the channel structure 13 may have improved high-rate characteristics and cycle characteristics.

The channel structure 13 included in the cathode active material layer 12 may have, for example, a through-hole extending from one surface 12a of the cathode active material layer to the other surface 12b. Thus, one or more channels 13a and 13b constituting the channel structure 13 are, for example, through-holes. Because the channel structure 13 includes through-holes, lithium ions may be easily transferred to the inside of the cathode active material layer 12 close to the cathode current collector 11. As a result, non-uniformity of current distribution between a region adjacent to the one surface 12a of the cathode active material layer 12 and a region adjacent to the other surface 12b of the cathode active material layer 12 may be suppressed.

An area A14 occupied by one or more channels 13a and 13b with respect to a total area of one surface 12a of the cathode active material layer 12 measured along one surface perpendicular to a thickness direction (Z direction) of the cathode active material layer 12 can be, for example, from about 1% to about 15%, from about 1% to about 10%, or from about 1% to about 5%. When the area A14 occupied by one or more channels 13a and 13b increases, energy density of the battery decreases. When the area A14 occupied by one or more channels 13a and 13b is within the above range, improved effects may be obtained by introducing the channels.

A diameter D of the one or more channels 13a and 13b of the cathode active material layer 12 can be, for example, from about 10 µm to about 300 µm, from about 10 µm to about 200 µm, or from about 10 µm to about 100 µm. When the channel has a diameter within the above range, cycle characteristics of the battery including the cathode may further be improved.

A pitch P between a plurality of channels 13a and 13b of the cathode active material layer 12 may be, for example, from about 50 µm to about 1000 µm, from about 50 µm to about 750 µm, from about 50 µm to about 500 µm, or from about 50 µm to about 250 µm. When the plurality of channels have a pitch therebetween within the above range, cycle characteristics of a battery including the cathode may further be improved.

The channel structure 13 of the cathode active material layer 12 may have a through-hole extending from one surface 12a of the cathode active material layer 12 to the other surface 12b. Therefore, the one or more channels 13a and 13b constituting the channel structure are, for example, through-holes. Because the channel structure 13 has through-holes, lithium ions may be easily transferred to the inside of the cathode active material layer 12 close to the cathode current collector 11. As a result, non-uniformity of current distribution between a region adjacent to the one surface 12a of the cathode active material layer 12 and a region adjacent to the other surface 12b of the cathode active material layer 12 may be suppressed.

Although not shown in the drawings, the cathode 10 may further include a deposited layer on the surface thereof. The deposited layer may be a layer deposited on the surface of the cathode via decomposition reaction of an electrolyte during a charging and discharging process of a battery including the cathode. The deposited layer is an electrolyte layer having ionic conductivity. The deposited layer may be, for example, a solid electrolyte layer. The deposited layer is, for example, a solid electrolyte interface (SEI) layer.

A density of the cathode active material layer 12 included in the cathode 10 can be from about 4.0 g/cc to about 4.9 g/cc, from about 4.2 g/cc to about 4.8 g/cc, or from about 4.3 g/cc to about 4.7 g/cc. The density of the cathode active material layer 12 is a density of a region excluding the channel structure 13. Because the cathode active material layer 12 is a sintered product, it has a high density. Due to the high density, the cathode active material layer 12 may provide an increased energy density compared to batteries known in the art.

The cathode active material layer 12 includes a plurality of crystallites and the plurality of crystallites may be aligned in one direction. For example, long axes of the plurality of crystallites may be aligned in a channel direction. The long axes of the plurality of crystallites may be aligned, for example, in a second direction (X direction) or a third direction (Y direction), to be aligned in the surface direction of the channels 13a and 13b.

Because the binder is removed from the cathode active material layer 12 by heat treatment in sintering process, the cathode active material layer 12 may be a binder-free layer. Because the cathode active material layer 12 does not include a binder, energy density of the cathode active material layer 12 may be increased. The cathode active material layer 12 may have a sintered layer (a binder-free layer).

Referring to FIG. 6, an area occupied by a plurality of through-holes with respect to a total area of one surface 12a of the cathode active material layer 12 measured along one surface perpendicular to a thickness direction (Z direction) of the cathode active material layer 12 is, for example, from about 1% to about 15%, from about 1% to about 10%, or from about 1% to about 5%. As the area occupied by the plurality of through-holes increases, energy density of the battery decreases. As the area occupied by the plurality of through-holes decreases, effects of introduction of the channels may not be obtained.

In addition, the cathode active material layer 12 may be a conductive material-free layer not including a conductive material. Alternatively, the cathode active material layer 12 may further include a conductive material. The conductive material may be, for example, a metallic conductive material. The metallic conductive material may be Al, Cu, Ni, Co, Cr, W, Mo, Ag, Au, Pt, Pb, or any combination thereof.

The anode 20 can be prepared as follows. For example, an anode active material, a conductive material, a binder, and a solvent are mixed to prepare an anode active material composition. The anode active material composition is directly coated on the anode current collector 21 and dried to prepare the anode 20 in which the anode active material layer 22 is located on the anode current collector 21. Alternatively, the anode 20 is prepared by casting the prepared anode active material composition on a separate support and laminating an anode active material film 22 separated from the support on the anode current collector 21.

The anode current collector 21 is formed of a conductive metal such as Cu, Au, Pt, Ag, Zn, Al, Mg, Ti, Fe, Co, Ni, Ge, In, Pd, and stainless steel, but is not limited thereto, and any suitable material commonly used in the art as the anode current collector 21 may be used. For example, the anode current collector 21 is copper (Cu) foil.

The anode active material is not particularly limited and any suitable anode active material layers commonly used in the art may also be used. The anode active material is, for example, an alkali metal (e.g., lithium, sodium, and potassium), an alkali earth metal (e.g., calcium, magnesium, and barium) and/or a certain transition metal (e.g., zinc) or an alloy thereof. The anode active material include, for example, a lithium metal, a metal alloyable with lithium, a transition metal oxide, a non-transition metal oxide, a carbonaceous material, or a combination thereof. The anode active material is, for example, lithium metal. Lithium metal is used as the anode active material, the current collector may or may not be omitted. When the current collector is omitted, a volume and a weight occupied by the current collector are reduced, energy density per unit weight of the lithium battery is increased. The another anode active material is, for example, an alloy of lithium metal and another anode active material. The anode active material is, for example, a metal alloyable with lithium. The metal alloyable with lithium is, for example, Si, Sn, Al, Ge, Pb, Bi, Sb, an Si—Y alloy (where Y is an alkali metal, an alkali earth metal, an element of groups 13, 14, 15 or 16, a transition metal, a rare earth element, or any combination thereof, except for Si), an Sn—Y alloy (where Y is an alkali metal, an alkali earth metal, an element of groups 13 or 14, a transition metal, a rare earth element, or any combination thereof, except for Sn), or a combination thereof. The element Y is, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or any combination thereof. The lithium alloy is, for example, a lithium-aluminum alloy, a lithium-silicon alloy, a lithium-tin alloy, a lithium-silver alloy, or a lithium-lead alloy. The anode active material is, for example, a transition metal oxide. The transition metal oxide is, for example, lithium titanium oxide, vanadium oxide, lithium vanadium oxide, or the like. The anode active material is, for example, a non-transition metal oxide. The non-transition metal oxide is, for example, SnO₂, SiOₓ (where 0<x<2), or the like. The anode active material is, for example, a carbonaceous material. The carbonaceous material is, for example, crystalline carbon, amorphous carbon, or any mixture thereof. The crystalline carbon is, for example, graphite such as natural or artificial graphite in a shapeless, plate, flake, spherical, or fibrous form. The amorphous carbon is, for example, soft carbon or hard carbon, mesophase pitch carbonization product, sintered coke, or the like.

For example, the anode active material is a silicon-based anode active material.

Amounts of the anode active material, the conductive material, the binder, and the solvent are those commonly used in lithium secondary batteries. At least one of the conductive material, the binder, and the solvent may be omitted according to the use and the configuration of the lithium battery.

An amount of the binder included in the anode is, for example, from about 0.1 wt% to about 10 wt%, or from about 0.1 wt% to about 5 wt% based on a total weight of the anode active material layer. An amount of the conductive material included in the anode is, for example, from about 0.1 wt% to about 10 wt% or from about 0.1 wt% to about 5 wt% based on the total weight of the anode active material layer. An amount of the anode active material included in the anode is, for example, from about 90 wt% to about 99 wt%, or about 95 wt% to about 99 wt% based on the total weight of the anode active material layer. When the anode active material is lithium metal, the anode active material layer may not include the binder and the conductive material.

Subsequently, the separator structure 30 according to an embodiment to be inserted between the cathode 10 and the anode 20 is prepared.

Next, the liquid electrolyte is prepared. The liquid electrolyte is, for example, an anhydrous electrolyte. The liquid electrolyte is, for example, an organic electrolyte. The organic electrolyte is prepared, for example, by dissolving a lithium salt in an organic solvent.

Any suitable organic solvent commonly used in the art may be used. The organic solvent is, for example, propylenecarbonate, ethylenecarbonate, fluoroethylenecarbonate, butylenecarbonate, dimethylcarbonate, diethylcarbonate, methylethylcarbonate, methylpropylcarbonate, ethylpropylcarbonate, methylisopropylcarbonate, dipropylcarbonate, dibutylcarbonate, benzonitrile, acetonitrile, tetrahydrofuran, 2-methyltetrahydrofuran, y-butyrolactone, dioxolane, 4-methyldioxolane, N,N-dimethyl formamide, dimethyl acetamide, dimethylsulfoxide, dioxane, 1,2-dimethoxyethane, sulfolane, dichloroethane, chlorobenzene, nitrobenzene, diethylene glycol, dimethyl ether, or a mixture thereof.

The lithium salt may be any suitable lithium salt commonly used in the art. The lithium salt is, for example, LiPF₆, LiBF₄, LiSbF₆, LiAsF₆, LiClO₄, LiCF₃SO₃, Li(CF₃SO₂)₂N, Li(FSO₂)₂N, LiC₄F₉SO₃, LiAlO₂, LiAlCl₄, LiN(CₓF₂ₓ₊₁SO₂)(C_{y}F_{2y+1}SO₂) (where x and y are each independently 1 to 20), LiCl, Lil, or a mixture thereof. A concentration of the lithium salt included in the liquid electrolyte is, for example, from about 0.1 M to about 10 M or from about 0.1 M to about 5 M.

The secondary battery includes the cathode, the anode, and the separator structure. The cathode, the anode, and the separator structure are stacked, wound, or folded, and then accommodated in a battery case (not shown). The liquid electrolyte is injected into the battery case and the battery case is sealed, thereby completing the manufacture of an electrochemical battery 1. The battery case has, for example, a rectangular shape, a thin-film shape, or a cylindrical shape, without being limited thereto.

A density of the cathode active material layer 12 included in the cathode 10 is, for example, from about 4.0 g/cc to about 4.9 g/cc, from about 4.2 g/cc to about 4.8 g/cc, or from about 4.3 g/cc to about 4.7 g/cc. Because the cathode active material layer 12 has such a high density, the secondary battery may provide an increased energy density.

The cathode active material layer 12 may include a compound selected from compounds represented by Formulae 2 to 5 below.

$${\text{Li}}_{\text{a}} {\text{Co}}_{\text{x}} {\text{M}}_{\text{y}} {\text{O}}_{2 - α} {\text{X}}_{α .}$$

In Formula 2, 1.0≤a≤1.2, 0.9≤x<1, 0≤y≤0.1, 0≤a≤0.2, and x+y=1, M is titanium (Ti), magnesium (Mg), aluminum (Al), gallium (Ga), silicon (Si), tin (Sn), nickel (Ni), yttrium (Y), vanadium (V), zirconium (Zr), hafnium (Hf), iron (Fe), chromium (Cr), copper (Cu), zinc (Zn), molybdenum (Mo), tungsten (W), niobium (Nb), manganese (Mn), tellurium (Te), barium (Ba), antimony (Sb), tantalum (Ta), germanium (Ge), boron (B), or any combination thereof, and X is F, S, Cl, Br, or any combination thereof.

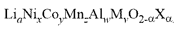

In Formula 3, 1.0≤a≤1.2, 0<x<1.0, 0≤-y<1.0, 0≤z<1.0, 0≤w<1.0, 0<v≤0.1, 0≤a≤0.2, x+y+z+w+v=1, M is titanium (Ti), magnesium (Mg), gallium (Ga), silicon (Si), tin (Sn), yttrium (Y), vanadium (V), zirconium (Zr), hafnium (Hf), iron (Fe), chromium (Cr), copper (Cu), zinc (Zn), molybdenum (Mo), tungsten (W), niobium (Nb), tellurium (Te), barium (Ba), antimony (Sb), tantalum (Ta), germanium (Ge), boron (B), or any combination thereof, and X is F, S, Cl, Br or any combination thereof.

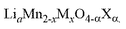

In Formula 4, 0.90≤a≤1.1, 0<x≤0.1, 0≤ a ≤0.2, M is titanium (Ti), magnesium (Mg), aluminum (Al), gallium (Ga), silicon (Si), tin (Sn), nickel (Ni), yttrium (Y), vanadium (V), zirconium (Zr), hafnium (Hf), iron (Fe), chromium (Cr), copper (Cu), zinc (Zn), molybdenum (Mo), cobalt (Co), tungsten (W), niobium (Nb), tellurium (Te), barium (Ba), antimony (Sb), tantalum (Ta), germanium (Ge), boron (B), or any combination thereof, and X is F, S, Cl, Br or any combination thereof.

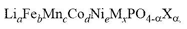

In Formula 5, 0.9≤a≤1.1, 0≤b<1, 0≤c<1, 0≤d<1, 0≤e<1, 0<x≤0.1, b+c+d+e+x=1, 0≤a≤0.2, M is titanium (Ti), magnesium (Mg), aluminum (Al), gallium (Ga), silicon (Si), tin (Sn), yttrium (Y), vanadium (V), zirconium (Zr), hafnium (Hf), chromium (Cr), copper (Cu), zinc (Zn), molybdenum (Mo), tungsten (W), niobium (Nb), tellurium (Te), barium (Ba), antimony (Sb), tantalum (Ta), germanium (Ge), boron (B), or any combination thereof, and X is F, S, Cl, Br or any combination thereof.

The cathode active material layer 12 may further include an undoped cathode active material. The undoped cathode active material may include, for example, a compound selected from compounds represented by Formulae 6 to 9 below.

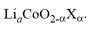

In Formula 6, 1.0≤a≤1.2, 0≤a≤0.2, and X is F, S, Cl, Br, or any combination thereof.

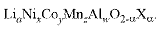

In Formula 7, 1.0≤a≤1.2, 0<x<1.0, 0≤y<1.0, 0≤z<1.0, 0≤w<1.0, 0≤a≤0.2, x+y+z+w=1, and X is F, S, Cl, Br, or any combination thereof.

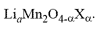

In Formula 8, 0.90≤a≤1.1, 0≤a≤0.2, and X is F, S, Cl, Br, or any combination thereof.

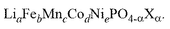

In Formula 9, 0.9≤a≤1.1, 0≤b<1, 0≤c<1, 0≤d<1, 0≤e<1, b+c+d+e=1, 0≤α≤0.2; and X is F, S, Cl, Br, or any combination thereof.

Hereinafter, the present disclosure will be described in more detail with reference to the following examples and comparative examples. However, the following examples are merely presented to exemplify the present disclosure, and the scope of the present disclosure is not limited thereto.

### Preparation of Separator Structure and Anode-Separator Assembly Including Same

### Example 1

A waterborne solution including 60 wt% of polytetrafluoroethylene (PTFE) was coated on a polyethylene film (thickness: 14 µm) that is a porous substrate, and dried to form a PTFE layer having a thickness of 1 µm. An amount of the waterborne solution was adjusted such that an amount of PTFE was about 3 wt% based on 100 wt% of a total weight of a separator including the porous substrate and the PTFE layer.

Subsequently, Li was deposited on the PTFE layer having an area of about 6.6 cm² to form a lithium metal layer to a thickness of about 3.82 µm and a deposition area of about 5.31 cm², followed by pressing to form an intermediate layer on the polyethylene film, thereby forming a separator structure. The intermediate layer included lithium fluoride and a defluorinated polymer represented by Formula 1 below, and the composition was confirmed by XPS analysis:

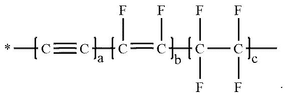

In Formula 1, a, b and c are from 0.01 to 0.99, respectively, and a sum thereof is 1. A degree of polymerization of the defluorinated polymer of Formula 1 was adjusted such that a number average molecular weight was 120,000 g/mol.

Separately, 98 wt% of a mixture of a silicon-carbon composite and artificial graphite (where a weight ratio of the silicon-carbon composite to artificial graphite was 1:1), 1.0 wt% of a styrene-butadiene rubber (SBR) binder (ZEON), 1.0 wt% of carboxymethylcellulose (CMC, NIPPON A&L) were mixed and added to distilled water, followed by stirring using a mechanical stirrer for 60 minutes to prepare an anode active material slurry. The anode active material slurry was applied to a 10 µm-thick copper current collector to a thickness of about 60 µm using a doctor blade and dried in a hot-air dryer at 100° C. for 0.5 hour, further dried in a vacuum at 120° C. for 4 hours, and roll-pressed to prepare an anode.

The anode was stacked on the lithium metal layer of the separator structure prepared according to the above-described process to prepare an anode-separator assembly.

In the separator structure prepared according to Example 1, the intermediate layer is located on 88% of an exposed surface area of the porous substrate, the porous substrate has a porosity of about 40%, and the porous substrate has a pore size of about 0.05 micron.

### Example 2

An anode-separator assembly was prepared in the same manner as in Example 1, except that a polyethylene film on which a first coating layer was formed according to the following process was used as the porous substrate instead of the polyethylene film.

The polyethylene film on which the first coating layer was formed was coated with a PTFE layer to a thickness of 1 µm by coating a waterborne solution including 60 wt% of polytetrafluoroethylene (PTFE) on the polyethylene film on which the first coating layer was formed and drying the coating. An amount of the waterborne solution was adjusted such that an amount of PTFE was about 3 wt% based on 100 wt% of a total weight of a separator including the porous substrate and the PTFE layer.

Subsequently, Li was deposited on the PTFE to form a lithium metal layer to a thickness of about 3.82 µm, followed by pressing to form an intermediate layer on a ceramic coating layer of the polyethylene separator coated with the ceramic coating layer.

The polyethylene separator coated with the first coating layer was prepared according to the following method. First, 70.71 wt% of an alumina dispersion, 0.33 wt% of PVA (polyvinyl alcohol, DAEJUNG Chemicals & Metals Co., Ltd.), and 28.96 wt% of DI water were mixed using a mechanical stirrer to prepare a first coating layer composition containing a solid content of 40 wt%. In this regard, the alumina dispersion (D50: 0.8 µm) was prepared by mixing 55 wt% of alumina (AES11, Sumitomo Chemical), 1.1 wt% of a (meth)acrylic copolymer (HCM-100S, Hansol Chemical), and 43.9 wt% of DI water using a bead mill.

The first coating layer composition was applied to one surface of a polyethylene film (Toray, 14 µm), by gravure coating to a thickness of 2 µm, dried at 70° C. for 10 minutes to form the first coating layer, thereby preparing the polyethylene separator coated with the first coating layer.

In the separator structure prepared according to Example 2, the intermediate layer is located on 88% of an exposed surface area of the porous substrate, the porous substrate has a porosity of about 40%, and the porous substrate has a pore size of about 0.05 micron.

### Comparative Example 1

A polyethylene separator (thickness: 14 µm) was stacked on the anode prepared according to Example 1 to prepare an anode-separator assembly.

### Comparative Example 2: Anode/Li Metal Layer/PTFE Layer/Porous Substrate (PE Film)

Lithium was deposited on the anode prepared according to Example 1 to prepare a lithium metal layer, and a PTFE layer was formed thereon at 21° C. by radio frequency magnetron sputtering.

A polyethylene film (thickness: 14 µm) was stacked on the resultant to prepare an anode-separator assembly.

According to Comparative Example 2, the anode is present in a highly reactive lithiated state during the manufacturing of an anode-separator assembly, and thus there is high probability of performance deterioration of the assembly and the battery.

On the contrary, for Examples 1 and 2, because the intermediate layer is formed on the porous substrate, the lithium metal layer is formed on the intermediate layer, and the anode is stacked on the lithium metal layer while forming the stack, and then the anode is brought into contact with lithium metal in the manufacture processes of Examples 1 and 2, safety may be obtained during the manufacturing process and deterioration in high-rate characteristics caused by lithium trapped in the separator may be avoided.

### Preparation of Lithium Secondary Battery

### Preparation Example 1

### Preparation of Cathode

A slurry including LiCoO₂ powder having an average particle diameter D50 of about 0.3 µm and used as a cathode active material, polyvinyl butyral as a binder, dibutyl phthalate as a plasticizer, an ester-based surfactant as a dispersant, and an azeotropic mixed solvent with 2:1 volume ratio of toluene and ethanol was coated on a conveying belt by the tape casting in the form of a sheet and dried at 200° C. to prepare a first cathode active material sheet having a thickness of 20 µm. An amount of LiCoO₂ contained in the first cathode active material sheet was 95 vol%.

A plurality of cathode active material sheets were stacked to prepare a cathode active material sheet laminate.

A plurality of through-holes penetrating the cathode active material sheet laminate from one surface to the other surface opposite to the one surface were formed by laser drilling.

A current collector slurry including an Ag—Pd alloy was applied to the other surface of the cathode active material sheet laminate having the through-holes by screen printing to form a current collector layer.

The cathode active material sheet laminate having through-holes was aligned on the current collector layer and sintered under atmospheric conditions at 1025° C. for 2 hours to prepare a three-dimensional cathode active material layer structure having a channel structure.

A thickness of the three-dimensional cathode active material layer structure in a first direction (Z direction) was 68 µm, a length thereof in a second direction (X direction) was 10,000.00 µm, and a length thereof in a third direction (Y direction) was 10000 µm. A diameter of the channel was 30 µm and a pitch of the channels was 100 µm. One channel includes a plurality of through-hole aligned in the first direction (Z direction).

A lithium secondary battery was prepared by stacking the above-described cathode on the separator structure of the anode-separator assembly prepared in Example 1 and using an electrolyte. As the electrolyte, a solution prepared by dissolving 1.15 M LiPF₆ in a mixed solvent of ethylene carbonate (EC), ethylmethyl carbonate (EMC), and dimethyl carbonate (DMC) (in a volume ratio of 3:4:3) was used.

### Preparation Example 2

A lithium secondary battery was prepared in the same manner as in Preparation Example 1, except that the anode-separator assembly of Example 2 was used instead of the anode-separator assembly of Example 1.

### Comparative Preparation Examples 1 and 2

Lithium secondary batteries were prepared in the same manner as in Preparation Example 1, except that the anode-separator assemblies of Comparative Examples 1 and 2 were used instead of the anode-separator assembly of Example 1.

### Evaluation Example 1: Charging and Discharging Characteristics (I)

The lithium secondary batteries of Preparation Example 1 and Comparative Preparation Example 1 were charged at a constant current of 0.1 C rate at 25° C. until a voltage reached 4.35 V (vs. Li), and the charging process was cut off at a current of 0.01 C rate in a constant voltage mode while maintaining the voltage of 4.35 V. Subsequently, the lithium secondary batteries were discharged at a constant current of 0.1 C rate until the voltage reached 3 V (vs. Li) (Formation process, 1^{st} cycle).

The lithium secondary batteries that underwent the formation process (1^{st} cycle) were charged at a constant current of 0.2 C rate at 25° C. until the voltage reached 4.35 V (vs. Li) and the charging process was cut off at a current of 0.02 C rate in a constant voltage mode while maintaining the voltage of 4.35 V. Subsequently, the lithium secondary batteries were discharged at a constant current of 0.2 C rate until the voltage reached 3 V (vs. Li) (2^{nd} cycle).

The lithium secondary batteries that underwent the 2^{nd} cycle were charged at a constant current of 0.5 C rate at 25° C. until the voltage reached 4.35 V (vs. Li) and the charging process was cut off at a current of 0.05 C rate in a constant voltage mode while maintaining the voltage of 4.35 V. Subsequently, the lithium secondary batteries were discharged at a constant current of 0.5 C rate until the voltage reached 3 V (vs. Li) (3^{rd} cycle).

The lithium secondary batteries that underwent the 3^{rd} cycle were charged at a constant current of 1 C rate at 25° C. until the voltage reached 4.35 V (vs. Li) and the charging process was cut off at a current of 0.1 C rate in a constant voltage mode while maintaining the voltage of 4.35 V. Subsequently, the lithium secondary batteries were discharged at a constant current of 1 C rate until the voltage reached 3.0 V (vs. Li) (4^{th} cycle).

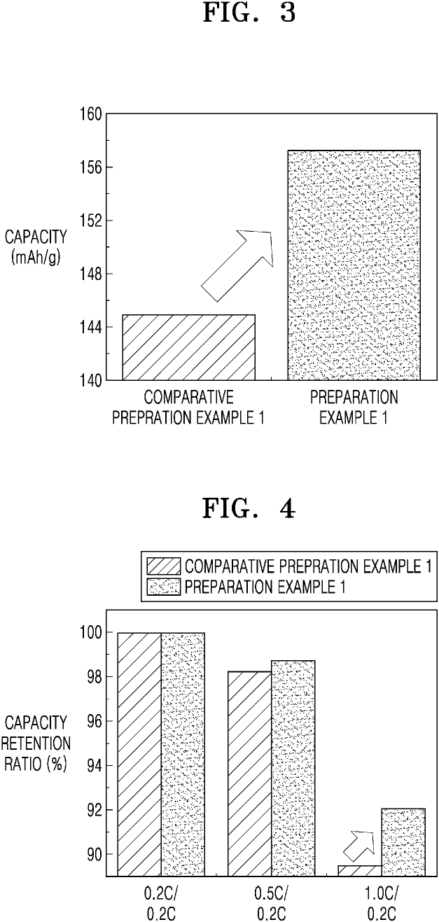

Some of the charging/discharging test results are shown in FIG. 3.

Referring to FIG. 3, it was confirmed that the discharge capacity of the lithium secondary battery of Preparation Example 1 at the 1^{st} cycle was increased by pre-lithiation, by about 8.5% compared to that of Comparative Preparation Example 1.

### Evaluation Example 2: Charging and Discharging Characteristics (II)

The lithium secondary batteries of Preparation Example 1 and Comparative Preparation Example 1 were charged at a constant current of 0.1 C rate at 25° C. until a voltage reached 4.35 V (vs. Li), and the charging process was cut off at a current of 0.01 C rate in a constant voltage mode while maintaining the voltage of 4.35 V. Subsequently, the lithium secondary batteries were discharged at a constant current of 0.1 C rate until the voltage reached 3 V (vs. Li) (Formation process, 1^{st} cycle).

The lithium secondary batteries that underwent the formation process (1^{st} cycle) were charged at a constant current of 0.2 C rate at 25° C. until the voltage reached 4.35 V (vs. Li) and the charging process was cut off at a current of 0.02 C rate in a constant voltage mode while maintaining the voltage of 4.35 V. Subsequently, the lithium secondary batteries were discharged at a constant current of 0.2 C rate until the voltage reached 3 V (vs. Li) (2^{nd} cycle).

The lithium secondary batteries that underwent the 2^{nd} cycle were charged at a constant current of 0.5 C rate at 25° C. until the voltage reached 4.35 V (vs. Li) and the charging process was cut off at a current of 0.05 C rate in a constant voltage mode while maintaining the voltage of 4.35 V. Subsequently, the lithium secondary batteries were discharged at a constant current of 0.5 C rate until the voltage reached 3 V (vs. Li) (3^{rd} cycle).

The lithium secondary batteries that underwent the 3^{rd} cycle were charged at a constant current of 1 C rate at 25° C. until the voltage reached 4.35 V (vs. Li) and the charging process was cut off at a current of 0.1 C rate in a constant voltage mode while maintaining the voltage of 4.35 V. Subsequently, the lithium secondary batteries were discharged at a constant current of 1 C rate until the voltage reached 3.0 V (vs. Li) (4^{th} cycle)

Capacity retention ratio is defined by Equation 3 below: Equation 3 Capacity retention ratio=[discharge capacity at 4^{th} cycle/discharge capacity at 2^{nd} cycle] x 100.

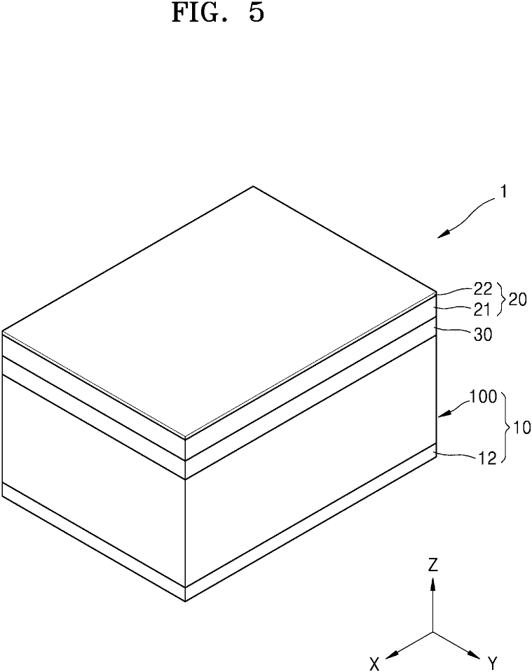

Some of the charging/discharging test results are shown in FIG. 4.

Referring to FIG. 4, the high-rate capacity retention ratio of the lithium secondary battery of Preparation Example 1 was 90% or more indicating excellent results. In addition, it was confirmed that high-rate characteristics of the lithium secondary battery of Preparation Example 1 were improved compared to the case of Comparative Preparation Example 1. This indicates that dendrite was formed in the case of Comparative Preparation Example 1, and thus lithium is accumulated in pores of the separator and an SEI layer was formed between the lithium metal layer and the separator and in the pores of the separator. The SEI layer served as a barrier layer.

On the contrary, in the case of Preparation Example 1, accumulation of lithium in the pores of the separator was inhibited and a stable SEI layer was formed on the surface of the anode during charging and discharging, and thus high-rate characteristics and lifespan characteristics were improved.

According to an embodiment, the anode-separator assembly may prevent lithium from being accumulated in the pores of the separator and form a stable SEI layer on the surface of the anode during charging and discharging. By using the anode-separator assembly, a secondary battery having high-density with increased capacity and improved high-rate characteristics may be prepared.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A separator structure for a secondary battery, the separator structure comprising:
a porous substrate;
an intermediate layer on the porous substrate and comprising lithium fluoride and a defluorinated polymer; and
a lithium metal layer on the intermediate layer.

2. The separator structure of claim 1,
wherein the intermediate layer and the lithium metal layer constitute an integrated structure.

3. The separator structure of claim 1,
wherein the defluorinated polymer and the lithium fluoride are present in pores of the porous substrate.

4. The separator structure of claim 1,
wherein the lithium fluoride and the defluorinated polymer of the intermediate layer are products of a reaction between a fluorine-containing polymer and lithium.

5. The separator structure of claim 4,
wherein the fluorine-containing polymer comprises polytetrafluoroethylene, polyvinylidenefluoride, polyhexafluoropropylene, polychlorotrifluoroethylene, polyvinylfluoride, perfluoroalkoxyalkane copolymer, fluorinated ethylene propylene copolymer, perfluoroelastomer, an ethylene chlorotrifluroethylene copolymer, or a combination thereof.

6. The separator structure of claim 1,
wherein the lithium metal layer has a thickness capable of providing both a lithium content compensating for an irreversible capacity loss of an anode during charging and discharging of the secondary battery and a lithium content required for defluorination of a fluorine-containing polymer of the intermediate layer, and
the lithium metal layer has a thickness capable of providing a lithium content satisfying Equation 1:
Equation 1
c = a + b
wherein in Equation 1, c is a lithium content of the lithium metal layer,
a is a lithium content required to form lithium fluoride via the reaction with a fluorine-containing polymer, and
b is a lithium content irreversibly lost from the anode during charging and discharging of the secondary battery.

7. The separator structure of claim 1,
wherein a thickness c1 of the lithium metal layer satisfies Equation 2:
Equation 2
c1 = a1 + b1
wherein in Equation 2, a1 is obtained by Equation 2-1 and indicates a thickness of lithium metal layer required to form lithium fluoride via a reaction with a fluorine-containing polymer,
Equation 2-1
Wherein in Equation 2-1, a1 = (mass of fluorine-containing polymer) X (capacity per unit weight of fluorine-containing polymer) X (⅟theoretical capacity of Li) X (⅟deposition area of lithium metal layer) X (⅟density of Li) X (1/10,000), and
b1 is obtained by Equation 2-2 and indicates a deposition thickness of the lithium metal layer related to pre-lithiation of an anode,
Equation 2-2
wherein in Equation 2-2, b1 = (irreversible capacity of anode) X (⅟theoretical capacity of Li) X (⅟deposition area of lithium metal layer) x (⅟density of Li) X (⅟10000).

8. The separator structure of claim 1,
wherein the defluorinated polymer is a copolymer comprising an unsaturated monomer repeating unit and a fluorine-containing monomer repeating unit.

9. The separator structure of claim 1,
wherein the defluorinated polymer is a polymer represented by Formula 1: 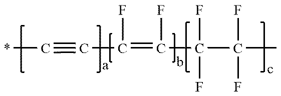
wherein in Formula 1, a, b and c are mole fractions, respectively, from 0.01 to 0.99, and the sum thereof is 1.

10. The separator structure of claim 1,
wherein a size of the lithium fluoride in the intermediate layer is from 1 nanometer to 1000 nanometers.

11. The separator structure of claim 1,
wherein the intermediate layer is located on 88% to 99.5% of an exposed surface area of the porous substrate.

12. The separator structure of claim 1,
wherein the intermediate layer comprises a central region including the defluorinated polymer and lithium fluoride and a peripheral region including a fluorine-containing polymer.

13. The separator structure of claim 1,
wherein the intermediate layer has ionic conductivity and is insoluble in an electrolytic solution.

14. The separator structure of claim 1,
wherein a ratio of a thickness of the lithium metal layer to a thickness of the intermediate layer is from 40,000:1 to 1.15:1.

15. The separator structure of claim 1,
wherein a thickness of the intermediate layer is from 0.0005 micron to 2.5 microns.

16. The separator structure of claim 1,
wherein a thickness of the lithium metal layer is from 0.0005 microns to 20 microns.

17. The separator structure of claim 1,
wherein an area of the intermediate layer is equal to or smaller than a total area of the porous substrate, and
an area of the lithium metal layer is smaller than a total area of the intermediate layer and equal to or greater than a total area of an anode of the secondary battery.

18. The separator structure of claim 1,
further comprising a first coating layer including ceramic particles and a binder on the porous substrate.

19. The separator structure of claim 18,
wherein the ceramic particles comprise particles of Al₂O₃, boehmite, BaSO₄, MgO, Mg(OH)₂, clay, silica (SiO₂), TiO₂, CaO, attapulgite, or a combination thereof.

20. The separator structure of claim 1,
wherein the porous substrate comprises polyethylene, polypropylene, or a combination thereof,
the porous substrate has a thickness of about 1 micron to about 100 microns,
the porous substrate has a porosity of about 5% to about 95%, and
the porous substrate has a pore size of about 0.01 micron to about 20 microns.

21. An anode-separator assembly for a secondary battery, the anode-separator assembly comprising:
an anode comprising an anode current collector and a first anode active material layer on a surface of the anode current collector; and
the separator structure of claim 1 on the anode.

22. The anode-separator assembly of claim 21,
wherein the porous substrate of the separator structure is a first separator, and
the anode-separator assembly further comprises:
a second anode active material layer on another surface of the anode current collector of the anode-separator assembly; a second lithium metal layer on the second anode active material layer;
a second intermediate layer on the second lithium metal layer and including a second defluorinated polymer and lithium fluoride; and
a second separator including a second porous substrate on the second intermediate layer,
wherein the anode-separator assembly has a structure in which the anode is enclosed by the first separator and the second separator by bonding ends of the first and second separators.

23. The anode-separator assembly of claim 22, further comprising a second adhesive layer arranged to extend from one end of the second intermediate layer and including a fluorine-containing polymer,
wherein a total area of the second intermediate layer and the second adhesive layer is equal to or smaller than a total area of the second porous substrate.

24. The anode-separator assembly of claim 21,
wherein the first anode active material layer comprises a metal or metalloid anode active material, a carbonaceous anode active material, or a combination thereof.

25. The anode-separator assembly of claim 21,
wherein the first anode active material layer is a silicon anode active material,
the silicon anode active material comprises silicon, a silicon-carbon composite, an Si-Q alloy, wherein Q is an element of alkali metals, alkali earth metals, elements of groups 13, 14, 15, and 16, transition metals, rare earth elements, or a combination thereof, except for Si), SiOₓ, wherein 0 < x < 2, or a combination thereof and optionally the silicon anode active material further comprises SiO₂.

26. The anode-separator assembly of claim 25, wherein the element Q is Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

27. The anode-separator assembly of claim 21,
wherein the first anode active material layer is a first silicon-carbon composite including silicon particles and a first carbonaceous material, a second silicon-carbon composite including a core in which silicon particles and a second carbonaceous material are mixed and a third carbonaceous material surrounding the core, or a combination thereof, and
the first carbonaceous material to the third carbonaceous material are each independently crystalline carbon, amorphous carbon, or a combination thereof.

28. The anode-separator assembly of claim 27,
wherein the second silicon-carbon composite comprises a core including silicon particles and crystalline carbon and an amorphous carbon coating layer formed on a surface of the core.

29. A secondary battery comprising:
the anode-separator assembly of claim 21; and
a cathode on the porous substrate of the anode-separator assembly.

30. The secondary battery of claim 29,
wherein a degree of pre-lithiation of the anode in the anode-separator assembly is from about 25% to about 70%.

31. A secondary battery comprising:
an anode comprising an anode current collector and an anode active material layer on the anode current collector; and
a separator structure comprising a porous substrate and an intermediate layer on the porous substrate, the intermediate layer including a defluorinated polymer and lithium fluoride.

32. The secondary battery of claim 31,
wherein the anode is lithiated by pre-lithiation.

33. A method of preparing the separator structure of claim 1 for a secondary battery, the method comprising:
forming a fluorine layer comprising a fluorine-containing polymer on a porous substrate; and
forming a lithium metal layer on the fluorine layer.

34. The method of claim 33,
wherein the forming of the lithium metal layer is performed by depositing lithium metal, and the lithium metal layer has a thickness of about 0.0005 micron to about 20 microns.
